(19) United States
(12) Patent Application Publication
(10) Pub. No.: US 2018/0036936 A1
(43) Pub. Date: Feb. 8, 2018

(54) APPARATUS AND METHOD OF PROCESSING A CONTINUOUS SHEET OF POLYMER MATERIAL

(71) Applicant: General Electric Company, Schenectady, NY (US)

(72) Inventors: Daniel Qi Tan, Rexford, NY (US); Norberto Silvi, Clifton Park, NY (US); Kevin Warner Flanagan, Troy, NY (US); Jeffrey S. Sullivan, Rexford, NY (US)

(21) Appl. No.: 15/228,787

(22) Filed: Aug. 4, 2016

(51) Int. Cl. B29C 55/06; B29C 71/02; B29C 35/16; B29B 13/02

(52) U.S. Cl. CPC B29C 55/06; B29B 13/02; B29C 71/02; B29C 35/16; B29K 2995/0039; B29K 2995/0007; B29L 2007/002

(57) ABSTRACT

A method of processing a continuous sheet of polymer material. The method includes routing the continuous sheet of polymer material from a first spool and along at least a first heated roller and a second heated roller, heating the continuous sheet of polymer material to a first temperature on the first heated roller and the second heated roller, and controlling a rotational speed of the first heated roller and the second heated roller such that the continuous sheet of polymer material is stretched when routed from the second heated roller to the first heated roller.

### BACKGROUND

The present disclosure relates generally to film capacitors and, more specifically, to an apparatus and method of forming polymeric thin films for use in film capacitors.

At least some known metalized film capacitors include two metal foil electrodes separated by a layer of polymer film. For example, some capacitors include two layers of metallic foil interleaved with two layers of polymer film, and the interleaved structure is wound about a spindle in a manner such that the two layers of metallic foil are electrically separated from each other. The layer of polymer film is typically fabricated from a dielectric material, such as polypropylene. Other high temperature resistant and high capacitance materials may also be suitable for use as the layer of polymer film. However, commercially available high temperature resistant and high capacitance materials, such as polyetherimide, are too thick for effective use in thin film and foil capacitors and may have manufacturing defects, such as wrinkling, thickness non-uniformity, surface defects, and residual solvent.

### BRIEF DESCRIPTION

In one aspect, a method of processing a continuous sheet of polymer material is provided. The method includes routing the continuous sheet of polymer material from a first spool and along at least a first heated roller and a second heated roller, heating the continuous sheet of polymer material to a first temperature on the first heated roller and the second heated roller, and controlling a rotational speed of the first heated roller and the second heated roller such that the continuous sheet of polymer material is stretched when routed from the second heated roller to the first heated roller.

In another aspect, an apparatus for use in processing a continuous sheet of polymer material is provided. The apparatus includes a first spool mount configured to receive a first spool having an unprocessed portion of the continuous sheet of polymer material wound thereon, a first heated roller, and a second heated roller. The continuous sheet of polymer material routed from the first spool and along at least the first heated roller and the second heated roller. The apparatus also includes a heating system and a drive system. The heating system is thermally coupled with at least one of the first heated roller and the second heated roller, and the heating system heats the continuous sheet of polymer material on the first heated roller and the second heated roller to a first temperature. The drive system actuates the first heated roller and the second heated roller, and controls a rotational speed of the first heated roller and the second heated roller such that the continuous sheet of polymer material is stretched when routed from the second heated roller to the first heated roller.

### DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an exemplary apparatus for use in processing a continuous sheet of polymer material; and

FIG. 2 is a side view of an exemplary roller assembly that may be used in the apparatus shown in FIG. 1.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

Embodiments of the present disclosure relate to an apparatus and method of forming polymeric thin films for use in film capacitors, for example. More specifically, the apparatus and method described herein facilitate uni-axially stretching a pre-formed polymer film fabricated from an amorphous, rather than semi-crystalline, polymer material. The polymer film is preheated, heated, stretched, annealed, and cooled in a continuous process such that a thin dielectric film having a thickness of less than about 4 microns is formed. The apparatus includes a series of roller elements that perform one or more of the process functions articulated above when the polymer film is routed therethrough. For example, the polymer film is stretched when routed between a pair of heated roller elements that operate at different rotational speeds. As such, manufacturing defects are mitigated in the polymer film, and the polymer film is stretched to a desired thickness in an efficient and continuous manner.

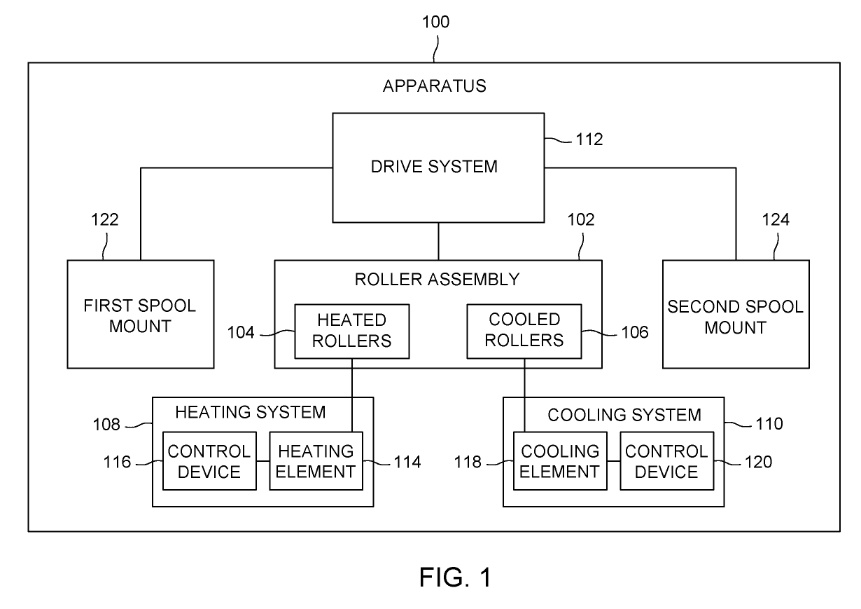

FIG. 1 is a block diagram of an exemplary apparatus 100 for use in processing a continuous sheet (not shown in FIG. 1) of polymer material. In the exemplary embodiment, apparatus 100 includes a roller assembly 102 including a plurality of rollers. More specifically, roller assembly 102 includes heated rollers 104 and cooled rollers 106. The continuous sheet of polymer material is routed along roller assembly 102, and heated rollers 104 and cooled rollers 106 perform one or more processing functions, as will be described in more detail below. For example, apparatus 100 further includes a heating system 108, a cooling system 110, and a drive system 112 coupled to roller assembly 102. Drive system 112 independently controls a rotational speed of heated rollers 104 and cooled rollers 106 to facilitate stretching the continuous sheet of polymer material, as will be described in more detail below. In addition, heating system 108 is thermally coupled to heated rollers 104 and cooling system 110 is thermally coupled to cooled rollers 106 to facilitate controlling the temperature of the continuous sheet of polymer material. In an alternative embodiment, apparatus 100 includes a film slitting system that trims the side edges of the continuous sheet before being routed to roller assembly 102.

Heating system 108 and cooling system 110 are embodied as any temperature control devices that enable apparatus 100 to function as described herein. For example, heating system 108 includes at least one heating element 114 coupled to heated rollers 104. In one embodiment, heating element 114 is an inductive heating device coupled directly to heated rollers 104. In addition, heated rollers 104 are fabricated from a thermally conductive material. As such, heat generated by heating element 114 is conducted through heated rollers 104 and transferred to the continuous sheet of polymer material. Heating system 108 further includes a control device 116 for independently controlling the temperature of each heated roller 104. In an alternative embodiment, heating element 114 is embodied as an external heater that transfers heat to the continuous sheet of polymer material through convection.

Cooling system 110 includes at least one cooling element 118 coupled to cooled rollers 106. In one embodiment, cooling element 118 is a heat exchange device that channels a flow of cooling fluid therethrough. Similar to heated rollers 104, cooled rollers 106 are likewise fabricated from a thermally conductive material. As such, as will be explained in more detail below, heat transferred from the continuous sheet of polymer material when routed from heated rollers 104 is conducted through cooled rollers 106 and dissipated in the working fluid channeled through cooling element 118. Cooling system 110 further includes a control device 120, such as a flow controller, for independently controlling the temperature of each cooled roller 106. In an alternative embodiment, cooling element 118 is any cooling device capable of maintaining cooled rollers 106 at a temperature for cooling the continuous sheet of polymer material.

Apparatus 100 further includes a first spool mount 122 and a second spool mount 124. Drive system 112 is coupled to first spool mount 122 and second spool mount 124 for independently controlling a rotational speed thereof. As will be described in more detail below, first spool mount 122 is operable for feeding the continuous sheet of polymer material towards roller assembly 102, and second spool mount 124 is operable for collecting the continuous sheet of polymer material received from roller assembly 102.

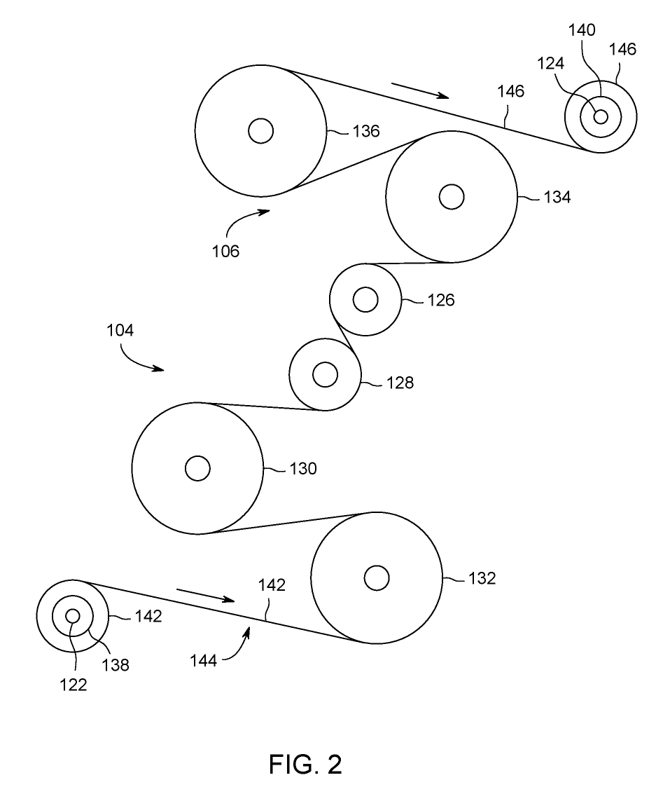

FIG. 2 is a side view of roller assembly 102 that may be used in apparatus 100 (shown in FIG. 1). In the exemplary embodiment, heated rollers 104 include a first heated roller 126, a second heated roller 128, a third heated roller 130, and a fourth heated roller 132. In addition, cooled rollers 106 include a first cooled roller 134 and a second cooled roller 136. First spool mount 122 receives a first spool 138 thereon, and second spool mount 124 receives a second spool 140 thereon. First spool 138 has an unprocessed portion 142 of a continuous sheet 144 of polymer material wound thereon. Continuous sheet 144 of polymer material is routed along roller assembly 102 and collected on second spool 140. More specifically, continuous sheet 144 of polymer material is processed when routed along roller assembly 102, and a processed portion 146 of continuous sheet 144 of polymer material is collected on second spool 140.

In the exemplary embodiment, the polymer material is an amorphous, high temperature resistant, and high capacitance material having a glass transition temperature greater than or equal to 140° C., for example. Exemplary polymer materials include, but are not limited to, polyetherimide, polytetrafluoroethylene, polycarbonate, polysulfone, polyethersulfone, modified high temperature polycarbonate, fluorine polyester, and polyvinylidene fluoride-polytetrafluoroethylene copolymers. In addition, continuous sheet 144 is a pre-formed sheet of polymer material formed in a melt-extrusion, solvent cast, or blow molding process, for example.

In operation, continuous sheet 144 is routed from first spool 138, through roller assembly 102, and collected on second spool 140. More specifically, continuous sheet 144 is routed from first spool 138 to fourth heated roller 132, from fourth heated roller 132 to third heated roller 130, from third heated roller 130 to second heated roller 128, from second heated roller 128 to first heated roller 126, from first heated roller 126 to first cooled roller 134, from first cooled roller 134 to second cooled roller 136, and from second cooled roller 136 to second spool 140. Heating system 108 is thermally coupled with at least one of first heated roller 126 and second heated roller 128. Heating system 108 heats continuous sheet 144 of polymer material on first heated roller 126 and second heated roller 128 to a first temperature. More specifically, heating system 108 heats first heated roller 126 and second heated roller 128 to the first temperature and heat is transferred to continuous sheet 144. In the exemplary embodiment, heating system 108 heats continuous sheet 144 of polymer material to the first temperature that is greater than a glass transition temperature of the polymer material. As such, continuous sheet 144 is softened for elastic deformation when stretched in roller assembly 102.

When heated to the first temperature, drive system 112 (shown in FIG. 1) actuates first heated roller 126 and second heated roller 128. Drive system 112 controls a rotational speed of first heated roller 126 and second heated roller 128 such that continuous sheet 144 of polymer material is stretched when routed from second heated roller 128 to first heated roller 126. More specifically, as described above, drive system 112 is capable of controlling the rotational speed of first heated roller 126 and second heated roller 128 independently of each other. Drive system 112 rotates first heated roller 126 at a greater rotational speed than second heated roller 128 such that an output rate of first heated roller 126 is greater than second heated roller 128, thereby stretching continuous sheet 144 of polymer material in a uni-axial direction defined along the routing path. In addition, rotating second heated roller 128 at a lower rotational speed than first heated roller 126 facilitates increasing the residence time of continuous sheet 144 on second heated roller 128, thereby allowing sufficient time for the temperature of continuous sheet 144 to increase to the first temperature. In one embodiment, a difference in rotational speeds of first heated roller 126 and second heated roller 128 is defined within a range between about 10 percent and about 30 percent. In addition, in one embodiment, drive system 112 controls the rotational speed of at least one of first heated roller 126 and second heated roller 128 such that continuous sheet 144 of polymer material is stretched to a thickness of less than or equal to about 4 microns.

In the exemplary embodiment, continuous sheet 144 is routed along fourth heated roller 132 and third heated roller 130, before being routed to second heated roller 128, such that continuous sheet 144 of polymer material is preheated to a temperature lower than the first temperature. More specifically, heating system 108 heats fourth heated roller 132 to a first preheated temperature and heats third heated roller 130 to a second preheated temperature, and heat is transferred from fourth heated roller 132 and third heated roller 130 to continuous sheet 144. The first preheated temperature and the second preheated temperature are both less than the first temperature. Preheating continuous sheet 144 of polymer material facilitates gradually increasing the temperature of the polymer material to reduce the formation of thermal stress within continuous sheet 144.

As described above, heating system 108 is capable of controlling the temperature of heated rollers 104 independently of each other. In some embodiments, heating system 108 operates such that a temperature difference between fourth heated roller 132 and third heated roller 130, and between third heated roller 130 and second heated roller 128 is less than a predetermined threshold. As such, a thermal gradient within continuous sheet 144 is reduced when increasing the temperature of continuous sheet 144, such that the formation of thermal stress within continuous sheet 144 is also reduced. In one embodiment, the predetermined threshold is less than or equal to about 200° F. (93.3° C.). In an alternative embodiment, a single preheated roller is implemented prior to routing continuous sheet 144 to second heated roller 128.

As described above, first cooled roller 134 receives continuous sheet 144 of polymer material routed from first heated roller 126. Cooling system 110 (shown in FIG. 1) is thermally coupled with first cooled roller 134, and cooling system 110 anneals continuous sheet 144 of polymer material on first cooled roller 134 to a third temperature lower than the first temperature. More specifically, cooling system 110 cools first cooled roller 134 to the third temperature, and heat is transferred from continuous sheet 144 to first cooled roller 134. In the exemplary embodiment, the third temperature is less than the glass transition temperature of the polymer material such that continuous sheet 144 is hardened on first cooled roller 134.

Moreover, second cooled roller 136 receives continuous sheet 144 of polymer material routed from first cooled roller 134. Cooling system 110 cools continuous sheet 144 of polymer material on second cooled roller 136 to a fourth temperature lower than the third temperature. More specifically, cooling system 110 cools second cooled roller 136 to the fourth temperature, and heat is further transferred from continuous sheet 144 to second cooled roller 136. As such, retraction of continuous sheet 144 is limited when processed portion 146 is collected on second spool 140.

The apparatus and method of forming polymeric thin films from pre-formed polymeric material, as described above, facilitating correcting deficiencies in known apparatuses and methods. More specifically, the apparatus includes heated rollers, cooled rollers, independent heating and cooling systems, and a drive system for selectively processing a continuous sheet of polymer material routed through the apparatus. The heating system heats the polymer material to greater than its glass transition temperature, and the rollers uni-axially stretch the polymer material after it has been heated. As such, the thickness of the continuous sheet is reduced and manufacturing defects in the pre-formed polymeric material is mitigated.

An exemplary technical effect of the apparatus and method described herein includes at least one of: (a) reducing the thickness of a continuous sheet of polymer material; (b) reducing and mitigating manufacturing defects typically found in a commercially available pre-formed polymeric film; and (c) enabling the use of high temperature resistant and high capacitance material in thin film capacitors.

Exemplary embodiments of an apparatus and method of processing a continuous sheet of polymeric material, and related components are described above in detail. The system is not limited to the specific embodiments described herein, but rather, components of systems and/or steps of the methods may be utilized independently and separately from other components and/or steps described herein. For example, the configuration of components described herein may also be used in combination with other processes, and is not limited to practice with only turbine assembles and related methods as described herein. Rather, the exemplary embodiment can be implemented and utilized in connection with many applications where stretching a film is desired.

Although specific features of various embodiments of the present disclosure may be shown in some drawings and not in others, this is for convenience only. In accordance with the principles of embodiments of the present disclosure, any feature of a drawing may be referenced and/or claimed in combination with any feature of any other drawing.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of processing a continuous sheet of polymer material, said method comprising:
routing the continuous sheet of polymer material from a first spool and along at least a first heated roller and a second heated roller;
heating the continuous sheet of polymer material to a first temperature on the first heated roller and the second heated roller; and
controlling a rotational speed of the first heated roller and the second heated roller such that the continuous sheet of polymer material is stretched when routed from the second heated roller to the first heated roller.

2. The method in accordance with claim 1, wherein heating the continuous sheet of polymer material comprises heating the continuous sheet of polymer material to the first temperature that is greater than a glass transition temperature of the polymer material.

3. The method in accordance with claim 1, wherein routing the continuous sheet of polymer material comprises routing the continuous sheet of polymer material from the first spool having an unprocessed portion of the continuous sheet of polymer material wound thereon.

4. The method in accordance with claim 1 further comprising collecting a processed portion of the continuous sheet of polymer material on a second spool.

5. The method in accordance with claim 1 further comprising:
preheating the continuous sheet of polymer material to a second temperature lower than the first temperature, the continuous sheet preheated on a third heated roller; and
routing the continuous sheet of polymer material from the third heated roller to the second heated roller.

6. The method in accordance with claim 5, wherein preheating the continuous sheet of polymer material comprises heating the second heated roller and the third heated roller such that a temperature difference therebetween is less than a predetermined threshold.

7. The method in accordance with claim 1 further comprising:
routing the continuous sheet of polymer material from the first heated roller to a first cooled roller; and
annealing the continuous sheet of polymer material on the first cooled roller to a third temperature lower than the first temperature.

8. The method in accordance with claim 7 further comprising:
routing the continuous sheet of polymer material from the first cooled roller to a second cooled roller; and
cooling the continuous sheet of polymer material on the second cooled roller to a fourth temperature lower than the third temperature.

9. The method in accordance with claim 1, wherein controlling a rotational speed of the first heated roller and the second heated roller comprises rotating the first heated roller at a greater rotational speed than the second heated roller.

10. The method in accordance with claim 1, wherein controlling a rotational speed of the first heated roller and the second heated roller comprises stretching the continuous sheet of polymer material to a thickness of less than or equal to about 4 microns.

11. An apparatus for use in processing a continuous sheet of polymer material, said apparatus comprising:
a first spool mount configured to receive a first spool having an unprocessed portion of the continuous sheet of polymer material wound thereon;
a first heated roller;
a second heated roller, the continuous sheet of polymer material routed from said first spool mount and along at least said first heated roller and said second heated roller;
a heating system thermally coupled with at least one of said first heated roller and said second heated roller, said heating system configured to heat the continuous sheet of polymer material on said first heated roller and said second heated roller to a first temperature; and
a drive system configured to actuate said first heated roller and said second heated roller, said drive system configured to control a rotational speed of said first heated roller and said second heated roller such that the continuous sheet of polymer material is stretched when routed from said second heated roller to said first heated roller.

12. The apparatus in accordance with claim 11, wherein said heating system is configured to heat the continuous sheet of polymer material to the first temperature that is greater than a glass transition temperature of the polymer material.

13. The apparatus in accordance with claim 11, wherein said first spool has the continuous sheet of an amorphous polymer material wound thereon.

14. The apparatus in accordance with claim 11 further comprising a second spool mount configured to receive a second spool thereon, said second spool configured to collect a processed portion of the continuous sheet of polymer material.

15. The apparatus in accordance with claim 11 further comprising a third heated roller configured to route the continuous sheet of polymer material to the second heated roller, wherein said heating system is thermally coupled with said third heated roller, said heating system configured to preheat the continuous sheet of polymer material on said third heated roller to a second temperature lower than the first temperature.

16. The apparatus in accordance with claim 15, wherein said heating system is further configured to heat said second heated roller and said third heated roller such that a temperature difference therebetween is less than a predetermined threshold.

17. The apparatus in accordance with claim 11 further comprising:
a first cooled roller configured to receive the continuous sheet of polymer material routed from said first heated roller; and
a cooling system thermally coupled with said first cooled roller, said cooling system configured to anneal the continuous sheet of polymer material on said first cooled roller to a third temperature lower than the first temperature.

18. The apparatus in accordance with claim 17 further comprising a second cooled roller configured to receive the continuous sheet of polymer material routed from said first cooled roller, wherein said cooling system is configured to cool the continuous sheet of polymer material on said second cooled roller to a fourth temperature lower than the third temperature.

19. The apparatus in accordance with claim 11, wherein said drive system is configured to rotate said first heated roller at a greater rotational speed than said second heated roller.

20. The apparatus in accordance with claim 11, wherein said drive system is configured to control the rotational speed of at least one of said first heated roller and said second heated roller such that the continuous sheet of polymer material is stretched to a thickness of less than or equal to about 4 microns.
